(19) United States
(12) Patent Application Publication
(10) Pub. No.: US 2011/0084054 A1
(43) Pub. Date: Apr. 14, 2011

(54) MASSAGE STONE WARMING APPARATUS

(76) Inventor: Susan Bahr, Ridgefield, CT (US)

(21) Appl. No.: 12/578,568

(22) Filed: Oct. 13, 2009

(51) Int. Cl. H05B 1/00; H05B 3/02

(52) U.S. Cl. 219/201; 219/482

(57) ABSTRACT

The present invention relates to a massage stone warming apparatus for warming massage stones comprising: a top member; a bottom member, where the top member and bottom member engage each other at several points; a plurality of pockets, said plurality of pockets are adapted to receive massage stones, and said plurality of pockets include integrated carbon fiber wires, said wires transfer heat to the massage stones; a plurality of slots, where said plurality of slots lie between the top member and the bottom member, said each slot is adapted to receive one of the plurality of pockets; a power supply that supplies power to the carbon fiber wires; and a regulating mechanism for regulating temperature within the plurality of pockets. The massage stone warming apparatus may include removable pouches to hold the massage stones.

### I. FIELD OF THE INVENTION

The present invention generally relates to massage stone warming apparatus, and, more particularly, to a massage stone warming apparatus for electrically heating and warming massage stones for use in a stone massage therapy.

### II. MOTIVATION FOR THE INVENTION

Recent times have seen tremendous increase in use of complementary and alternative medicine therapies such as chiropractics, massage therapy, herbal medicine, and the like. Many people that frequent day spas or private massage practices do so to have licensed/certified massage therapists perform their session. Massage therapy is used to relieve muscle tension, spasms, inflammation, fluid retention, aches, stiffness, and pain. Massage therapy is also useful for increasing circulation of blood and lymph, general flexibility of a body, increased tissue elasticity, and the like. More specifically, massage therapy involves the manual manipulation of soft body tissues to enhance the general health and well-being of a patient or a user. The manual manipulation involves applying a pressure, a tension, a vibration to the soft body tissues with the help of various aids such as massage stones, massage lotions, essential oils, and the like. Based on the type of the aid used, massage therapy has been categorized into many types, such as stone massage therapy, aromatherapy massage therapy, magnetic massage therapy, and the like. Massage stones are used in stone massage therapy by heating the massage stones before applying to the soft body tissues. Massage stones are usually made of basalt, which is rich in iron and has the ability to retain heat for a longer period.

Conventionally, massage stones are immersed in water that is then heated in an electric heating device until the massage stones attain a certain temperature range. After heating the hot massage stones are removed and applied to the soft body tissues. Warm stones are placed on the soft tissues over various energy centers of the body, which may improve energy flow, the warmth may increase circulation and blood flow in the area of application, and may bring the client to a heightened relaxation state. The therapist also massages the client's soft tissues with the warm stones, which may relieve tension, loosen adhesions, increase circulation, etc.

However, massage stones tend to lose heat attained during the massage. A therapist conducting the stone massage therapy takes utmost care to ensure that the massage stones are a suitable temperature for use during therapy. Moreover, the therapists usually use a large number of massage stones to ensure successful use of the massage stones. A massage therapist must use care when using stones, in particular, use of a heating unit filled with hot water may be unpractical because the therapist is exposed to a burn risk. Many times the stones are too hot, or not hot enough. Being too hot leads to wasted time for the client, as the therapist needs to use thongs or a large spoon, which is noisy and takes away from the relaxation of the session, so the therapist does not get burned. The therapist must cool the stones with cool water before they can be applied to the client's skin.

Other issues involved in stone massage therapy include: 1) therapist/client contact may be interrupted every time the therapist must stop to get new heated stones because the stones in use have lost their heat; slip and fall hazards due to the dripping of water on the floor; clean up and sanitizing the stones is very time consuming after a heated stone massage session especially if dealing with multiple heated stone sessions in a row.

With the above mentioned, there is a need for a better, healthier, and more greener way to heat the massage stones to give the therapist a safer environment and the client a session with less interruptions and a more relaxing therapeutic experience. Accordingly, there persists a need for a massage stone warming apparatus for electrically warming massage stones during a stone massage therapy.

Therefore, it is an object of the present invention to provide a massage stone warming apparatus for electrically warming massage stones during a stone massage therapy.

It is further an object of the present invention to obviate the above and other disadvantages from existing art and to provide a massage stone warming apparatus which is a lightweight, portable, safe, user friendly, attractive and has a low production cost.

It is further an object of the present invention to provide a massage stone warming apparatus which may replace conventional method of warming massage stones.

It is further an object of the present invention to provide a massage stone warming apparatus capable of maintaining a temperature control of massage stones during a stone massage therapy.

### III. SUMMARY OF THE INVENTION

The present invention relates to a massage stone warming apparatus for warming massage stones comprising: a top member; a bottom member, where the top member and bottom member engage each other at several points; a plurality of pockets, said plurality of pockets are adapted to receive massage stones, and said plurality of pockets include integrated carbon fiber wires, said wires transfer heat to the massage stones; a plurality of slots, where said plurality of slots lie between the top member and the bottom member, said each slot is adapted to receive one of the plurality of pockets; a power supply that supplies power to the carbon fiber wires; and a regulating mechanism for regulating temperature within the plurality of pockets. The massage stone warming apparatus may include removable pouches to hold the massage stones. The massage stone warming may further comprise a plurality of attachment members, where said attachment members securely hold the warming apparatus on a massage table structure.

### IV. DESCRIPTION OF THE DRAWING

The advantages and features of the present invention will become better understood with reference to the detailed description taken in conjunction with the accompanying drawing, and in which:

FIG. 1 illustrates a perspective front view of a massage stone warming apparatus, in accordance with an embodiment of the present invention.

### V. DESCRIPTION OF THE INVENTION

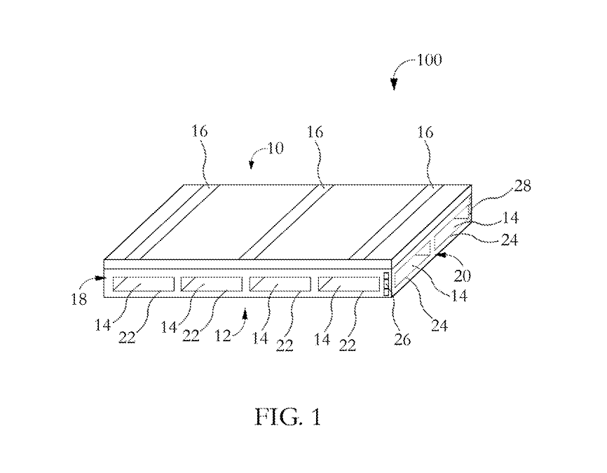

The best mode for carrying out the present invention is presented in terms of its preferred embodiment, herein depicted in FIG. 1. The preferred embodiment described herein detail for illustrative purposes are subject to many variations. It is understood that various omissions and substitutions of equivalents are contemplated as circumstances may suggest or render expedient, but are intended to cover the application or implementation without departing from the spirit or scope of the present invention.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

The present invention provides a massage stone warming apparatus for warming massage stones during stone massage therapy. The present invention is readily adaptable for a massage table or similar device. The massage stone warming apparatus is a non-inflammable blanket shaped structure that may be removably attached to the massage table. The present invention may be used at a multitude of places such as homes or commercial establishments such as massage therapy centers, spas, beauty parlors or salons. Further, simple configuration and portability aspects of the present invention makes the massage stone warming apparatus user friendly and devoid of any unfavorable circumstances such as burns or other injuries. In the preferred embodiment of the present invention, the massage stone warming apparatus has been illustrated and explained in conjunction with a massage table, and the same may not be construed as limiting the scope of the present invention.

As illustrated in FIG. 1, the present invention provides a massage stone warming apparatus 100 (hereinafter referred to as ‘warming apparatus 100’) for warming massage stones (not shown) during stone massage therapy. The warming apparatus 100 includes a top member 10 and a bottom member 12 engaged with each other at several points to configure a plurality of pockets 14 therebetween. More specifically, the top member 10 and the bottom member 12 configure a twin-blanket like structure having the plurality of pockets 14 between the top member 10 and the bottom member 12. The plurality of pockets 14 are configured to hold the massage stones therein. The warming apparatus 100 may have a rectangular shape configured to be readily adaptable on any massage table structure (not shown). The top member 10 and the bottom member 12 are made of non-inflammable material covered with soft fabric, for example, flannel or fleece. Further, the top member 10 of the warming apparatus 100 includes a plurality of attachment members 16 thereon, for securely holding the warming apparatus 100 on the massage table structure.

Further, the warming apparatus 100 includes a front side portion 18, a rear side portion (not shown), a first side portion 20, and a second side portion (not shown), collectively configuring sidewalls of the warming apparatus 100. Further, the front side portion 18 includes a first set of plurality of slots 22 to provide openings for the plurality of pockets 14 of the warming apparatus 100. Furthermore, the first side portion 20 includes a second set of plurality of slots 24 to provide openings for the plurality of pockets 14. Likewise, the rear side portion and the second side portion also include a plurality of slots (not shown) for providing openings for the plurality of pockets 14.

Further, the plurality of pockets 14 may be configured with integrated carbon fiber wires (not shown) for heating the massage stones placed within the plurality of pockets 14. More specifically, an external wiring (not shown) connected to an external power source (not shown) may provide the requisite power for heating the integrated carbon fiber wires, thereby warming the massage stones. Also, the plurality of pockets 14 may be provided with removable pouches (not shown) to hold the massage stones, which may act as liner and can be removed for washing.

The front side portion 18 of the warming apparatus 100 includes an operating mechanism 26, such as an on/off switch, for controlling the operation of the warming apparatus 100. In an instance, where an ‘on’ position of the on/off switch is attained, the warming apparatus 100 receives power supply from the external power source for heating the integrated carbon fiber wires within the plurality of pockets 14. In other instance, where an ‘off’ position of the on/off switch is attained, the warming apparatus 100 ceases to receive power supply from the external power source, and as such no generation of the heat within the plurality of pockets 14 occurs.

Further, the warming apparatus 100 may also include a regulating mechanism 28 for regulating temperature within the plurality of pockets 14. More specifically, the regulating mechanism 28 may be configured on the first side portion 20 of the warming apparatus 100 for regulating the temperature within the plurality of pockets 14 to any of the desired level, such as, a low temperature, a medium temperature and a high temperature depending upon a preference of a user undergoing stone massage therapy. It will be apparent to those skilled in the art that placement of the operating mechanism 26 and the regulating mechanism 28 on the front side portion 18 and the first side portion 20, respectively, is set forth herein for purposes of illustration and that the present invention is not limited to placement of the operating mechanism 26 and the regulating mechanism 28 on the front side portion 18 and the first side portion 20 respectively. The operating mechanism 26 or the regulating mechanism 28 may be configured on the rear side portion or the second side portion.

During operation, the plurality of pockets 14 may be filled with massage stones. More specifically, the massage stones may be placed within the removable pouches present within the plurality of pockets 14. Thereafter, the massage stones may be heated within the plurality of pockets 14 by the integrated carbon fiber wires. Further, the warming apparatus 100 is provided with the operating mechanism 26 for initiating power supply from the external power source to the integrated carbon fiber wires for heating the massage stones. The operating mechanism 26 is also configured to break the power supply to the integrated carbon fiber wires after the massage stones have been heated. Further, the regulating mechanism 28 of the warming structure 100 is adapted to regulate temperature of the massage stones in order to provide different ranges of temperature such a low temperature, medium temperature or a high temperature. A user may lie down on the warming apparatus 100 to undergo a stone massage therapy, after the operating mechanism 26 and the regulating mechanism 28 have been set. Once the stone massage therapy has been accomplished, the operating mechanism 26 cuts the power supply to the integrated carbon fiber wires. Further, the warming apparatus 100 is readily adapted to be rolled up into a compact structure for easy transportation and storage. The warming apparatus 100 may also include a shoulder strap (not shown) for transportation of the warming apparatus 100.

The warming apparatus 100 may be of different sizes and shapes. In an embodiment of the present invention, the warming apparatus 100 may be about 6 inches in length and about 6 inches in width. The warming apparatus 100 is readily adaptable for use by people of all age groups. The warming apparatus 100 is also suited for people having breathing problems and skin problems.

In an exemplary embodiment of the present invention, the warming apparatus 100 may be a small pouch like structure for massaging a hand or a foot of a user during the stone massage therapy. The pouch like structure may have an opening for storing one or more massage stones thereon, and may be heated electrically by supplying power supply to the pouch like structure from the external power supply source.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

What is claimed is:

1. A massage stone warming apparatus for warming massage stones comprising:
a. a top member;
b. a bottom member, where the top member and bottom member engage each other at several points;
c. a plurality of pockets, said plurality of pockets are adapted to receive massage stones, and said plurality of pockets include integrated carbon fiber wires, said wires transfer heat to the massage stones;
d. a plurality of slots, where said plurality of slots lie between the top member and the bottom member, said each slot is adapted to receive one of the plurality of pockets;
e. a power supply that supplies power to the carbon fiber wires; and
f. a regulating mechanism for regulating temperature within the plurality of pockets.

2. The massage stone warming apparatus according to claim 1, further including removable pouches to hold the massage stones.

3. The massage stone warming apparatus according to claim 1, further comprising a plurality of attachment members, where said attachment members securely hold the warming apparatus on a massage table structure.

4. The massage stone warming apparatus according to claim 1, further comprising an operating mechanism, where said operating mechanism includes an on/off switch, said switch controlling the power supply to the carbon fiber wires.

5. The massage stone warming apparatus according to claim 1, where the top member and bottom member are made of non-flammable material covered with soft fabric.

6. The massage stone warming apparatus according to claim 1, where said regulating mechanism regulates temperature between at least three temperature settings, low, medium and high.
